(19) United States
(12) Patent Application Publication
(10) Pub. No.: US 2026/0010015 A1
(43) Pub. Date: Jan. 8, 2026

(54) INTERCHANGEABLE NOSE PAD AND TETHER SYSTEM

(71) Applicant: Bex Sunglasses, LLC, Logandale, NV (US)

(72) Inventor: Jason Adams, Logandale, NV (US)

(73) Assignee: Bex Sunglasses, LLC, Logandale, NV (US)

(21) Appl. No.: 19/226,887

(22) Filed: Jun. 3, 2025

Related U.S. Application Data
(60) Provisional application No. 63/667,748, filed on Jul. 4, 2024.

(51) Int. Cl. G02C 5/12; G02C 5/14

(52) U.S. Cl. CPC G02C 5/126; G02C 5/143

(57) ABSTRACT

An eyewear system includes a nose portion, a first pair of nose pads couplable to the nose portion, a pair of temple arms, and a pair of temple tips, wherein each temple tip includes an aperture configured to receive a respective second nose pad, the nose pads configured to be removably securable (e.g., interference fit, snap fit) within the respective apertures. The eyewear system may also include a tether having a first end and a second end, wherein each end has a protrusion in the shape of a nose pad and configured to be removably securable within the respective temple tip apertures.

### CROSS-REFERENCE TO RELATED APPLICATIONS

This application claims the benefit of U.S. Provisional Application Ser. No. 63/667,748 filed on Jul. 4, 2024, which is incorporated herein by reference.

### TECHNICAL FIELD

The present disclosure relates to eyewear. More particularly, the present disclosure relates to interchangeable nose pads and a tether system for eyeglasses and sunglasses.

### BACKGROUND

In the eyewear industry, the comfort and fit of glasses are significantly influenced by the design and functionality of nose pads and temple tips. Leading brands such as Oakley®, Ray-Ban®, Maui Jim®, and Warby Parker® have developed various approaches to enhance user comfort and eyewear stability. However, each approach has its shortcomings.

For example, Oakley, known for sports sunglasses, incorporates interchangeable nose pads designed to aid with fit during physical activities. Specific models like the Oakley Radar EV Path, Oakley Flak 2.0 XL, and Oakley Jawbreaker include additional nose pads in their packaging, offering storage solutions that range from small pouches to comprehensive hard cases. These storage solutions must be carried by the user if they are to be available for use in particular activities or in the event of damaged or worn-down nose pads. These interchangeable nose pads are typically made from grippy, sweat-resistant materials, catering to athletes and active users. Oakley also does not offer the interchangeable nose pad design on the majority of the brand's sunglass line.

Ray-Ban, focusing on style and everyday comfort, employs adjustable nose pads. These are generally metal pads with silicone covers, allowing for a customizable fit, but not designed to be interchangeable. This approach emphasizes comfort and adjustability over modularity, and does not allow the end-user to swap out nose pads at any point during their user experience.

Maui Jim emphasizes comfort with fixed nose pads designed to reduce pressure points and slippage. Their nose pads are also not interchangeable, instead prioritizing long-term comfort and stability through the use of high-quality materials.

Warby Parker offers affordable eyewear, featuring simple, fixed nose pads designed for comfort. Like Maui Jim and Ray-Ban, Warby Parker's products do not include interchangeable nose pads, focusing instead on a fixed approach.

In addition to nose pads, there is also a need for better tether systems for eyewear. Many tethers exist in the prior art, but they have several shortcomings as well. For example, some tethers are intended to slip over and cover the ends of the temple tips. However, if the temple tips are too narrow, the tether will not stay attached and will slip free from the temple tips. Further, the tether may begin to fray or loosen over time, which may lead to failure.

Additionally, tethers that slip over the temple tip create a bulky temple tip, which may be uncomfortable for a user, even when soft materials, such as cotton, are used. Further, neoprene straps, fabrics, and metal chains can cause skin irritation and discomfort. Other tethers include a ring or loop that is fastened to each temple arm of the eyewear. This typically allows the tether to slide back and forth on the temple arms, which creates discomfort, inconsistent positioning, may scratch the temple arms, or have other drawbacks. As a result, there is a need for a tether system that does not create discomfort, remains attached to the temple tip, is consistently positioned, and may be easily adjusted to the desires of the user.

Despite the advancements in the prior art, there remains a need for a universal, interchangeable nose pad and temple tip system that provides both comfort and convenience. Existing solutions either lack interchangeability or fail to integrate nose pads and a convenient storage solution into a cohesive system. Users often struggle with the inconvenience of lost or damaged nose pads, which can significantly affect the fit and usability of their eyewear, as well as inconsistent tethers. The present disclosure seeks to solve these and other problems.

### SUMMARY OF EXAMPLE EMBODIMENTS

In some embodiments, an eyewear system comprises a bridge, a nose portion, a first pair of nose pads couplable to the nose portion, a pair of temple arms, and a pair of temple tips, wherein each temple tip comprises a temple tip aperture configured to receive a second nose pad, the first and second nose pads each configured to be removably securable (e.g., interference fit, snap fit) within the respective temple tip apertures.

In some embodiments, the eyewear system further comprises a tether comprising a first end and a second end, wherein each end comprises a protrusion in the shape of a nose pad and configured to be removably securable within the respective temple tip apertures.

In some embodiments, a method of interchanging nose pads for eyewear comprises removing a first pair of nose pads coupled to the nose portion, removing a second pair of nose pads from the temple tips, such as by applying pressure to force each respective second nose pad from the temple tip apertures, coupling each second nose pad to the nose portion, and inserting the first pair of nose pads into the respective temple tip apertures.

In some embodiments, a method of coupling a tether to the eyewear further includes coupling the tether to the temple tips by forcing a first protrusion of a first end of the tether into a first temple tip aperture, and forcing a second protrusion of a second end of the tether into a second temple tip aperture, each protrusion configured to be secured by interference fit, snap fit, or other removably securable means within the respective temple tip aperture.

### BRIEF DESCRIPTION OF THE DRAWINGS

FIG. 1 illustrates a front, left, bottom perspective view of an eyewear system;

FIG. 2 illustrates various views of an eyewear system illustrating the swappable nature of the nose pads;

FIG. 3 illustrates a detailed rear, left side perspective view of an eyewear system;

FIG. 4 illustrates a detailed rear, left side perspective view of an eyewear system with a nose pad decoupled from a temple tip aperture;

FIG. 5 illustrates a perspective view of a pair of nose pads of an eyewear system;

FIG. 6 illustrates a detailed, left side perspective view of a user applying pressure to remove a nose pad stored in a temple tip aperture of an eyewear system;

FIG. 7 illustrates a detailed, left side perspective view of a user applying pressure to remove a nose pad stored in a temple tip aperture of an eyewear system;

FIG. 8 illustrates a detailed left side perspective view of a nose aperture for receiving a nose pad of an eyewear system;

FIG. 9 illustrates a detailed, rear, left side perspective view of a user applying pressure to insert a nose pad into a nose aperture of an eyewear system;

FIG. 10 illustrates a side perspective view of an eyewear system for metal frames;

FIG. 11 illustrates a side perspective view of an eyewear system that is rimless (no frame);

FIG. 12 illustrates a front, top, left side perspective view of an eyewear system comprising a tether; and

FIG. 13 illustrates a detailed, left side perspective view of a tether partially removed from a temple tip aperture of an eyewear system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a universal, interchangeable nose pad and temple tip system that provides both comfort and convenience. Existing solutions either lack interchangeability or fail to integrate nose pads and a convenient storage solution into a cohesive system. Users often struggle with the inconvenience of lost or damaged nose pads, which can significantly affect the fit and usability of their eyewear, as well as inconsistent tethers. The eyewear system disclosed herein solves these and other problems.

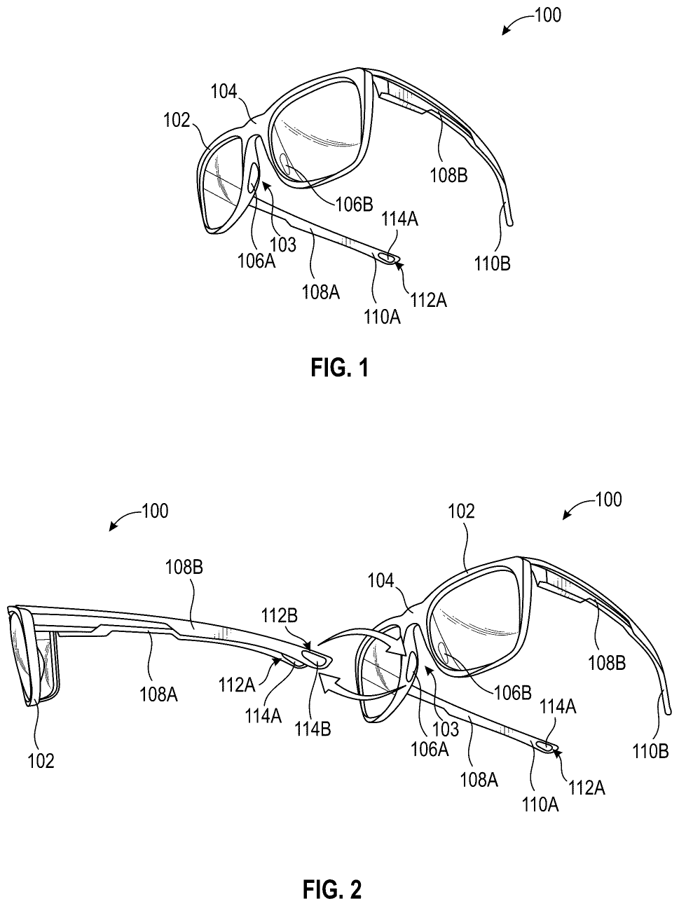

In some embodiments, as shown in FIGS. 1-2, an eyewear system 100 comprises frame 102, a bridge 104, a first pair of nose pads 106A-B couplable to a nose portion 103 of the frame 102 or bridge 104 (depending on the style of eyewear, as will be discussed in more detail later herein), a pair of temple arms 108A-B, and a pair of temple tips 110A-B, wherein each temple tip 110A-B comprises a respective temple tip aperture 112A-B configured to receive a respective second nose pad 114A-B.

As appreciated from FIG. 2, the first and second nose pads 106A-B, 114A-B are each configured to be interchangeable and removably securable (e.g., interference fit, snap fit) within the respective temple tip apertures 112A-B. While two eyewear systems 100 are shown in FIG. 2, it will be understood that it is the same pair shown from different angles and illustrating the interchangeability (via the large arrows) of the first and second nose pads 106A-B, 114A-B between the nose portion 103 and the temple tip apertures 112A-B. However, they may also be swappable between different pairs of eyewear systems as well.

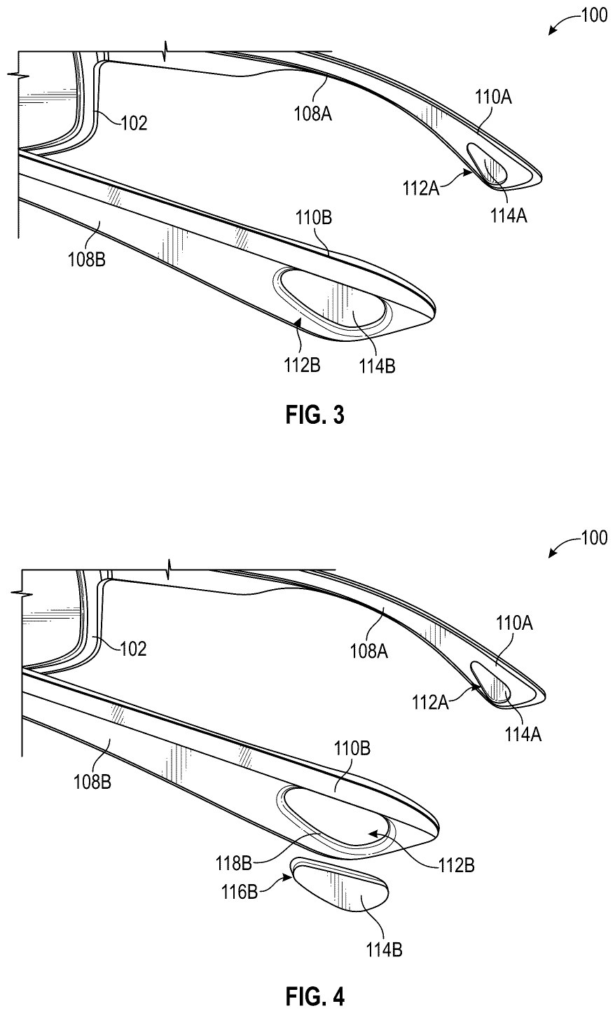

FIGS. 3-4 illustrate a detailed view of the second nose pads 114A-B in relation to the temple tips 110A-B. Specifically FIG. 3 illustrates both nose pads 114A-B coupled within the temple tip apertures 112A-B, respectively. Referring to FIG. 4, second nose pad 114B is shown decoupled from the temple tip aperture 112B. It will be appreciated that the temple tip apertures 112A-B comprise a shape that is complementary to the first and second nose pads 106A-B, 114A-B so as to receive them therein.

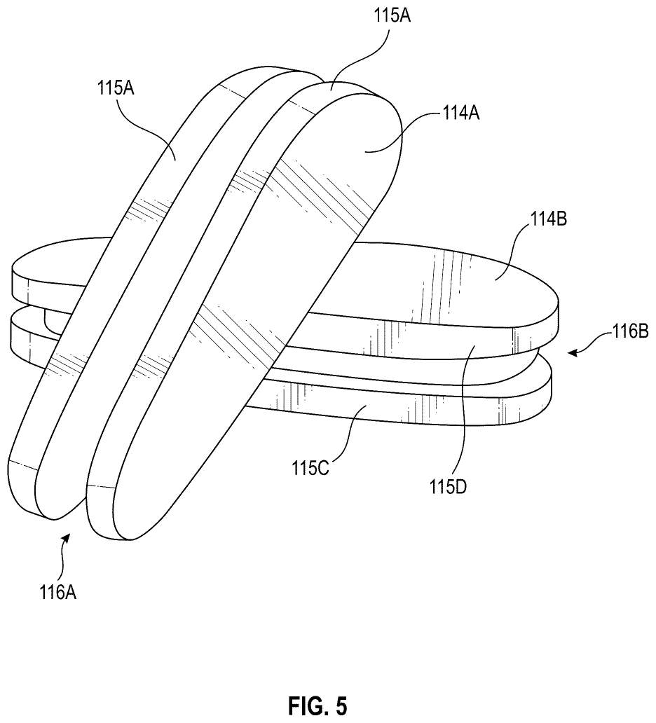

To ensure the nose pads 106A-B, 114A-B remain selectively coupled to the temple tip apertures 112A-B, a tongue and groove arrangement, or similar, may be used. For example, and as best seen in FIGS. 5-7, the second nose pads 114A-B (and although not shown, it is understood that the first nose pads 106A-B have the same configuration) may each comprise a respective channel or groove 116A-B around its outer perimeter that is configured to receive a respective ridge or tongue 118B (FIG. 7; second tongue not visible in these views) located on the inner perimeter of each temple tip aperture 112A-B. Referring to FIG. 5, the groove 116A of nose pad 114A forms a divide between a first side 115A and a second side 115B, and the groove 116B of the nose pad 114B forms a divide between a first side 115C and a second side 115D.

As a result, the groove 116B of the second nose pad 114B is complementarily shaped so as to receive the tongue 118B of the temple tip aperture 112B, with the tongue 118B being interposed between the first and second sides 115C, 115D, respectively. As will be understood, a user may apply force to the nose pad 114B to both remove or insert it into the temple tip aperture 112B, seating or unseating the tongue 118B within the groove 116B, for example. In other words, the nose pads 106A-B, 114A-B are made of sufficiently flexible material so as to flex, when under pressure, to be inserted or removed from the frame 102 and/or temple tip apertures 112A-B, respectively. While shown as the nose pads 106A-B, 114A-B as having a respective groove 116A-B and the temple tip apertures 112A-B as having tongues 116A-B, such configuration may be reversed without departing herefrom. In other words, the nose pads may have tongues and the temple tip apertures may have grooves. Other methods of interference fit, or similar coupling methods, may be used without departing herefrom.

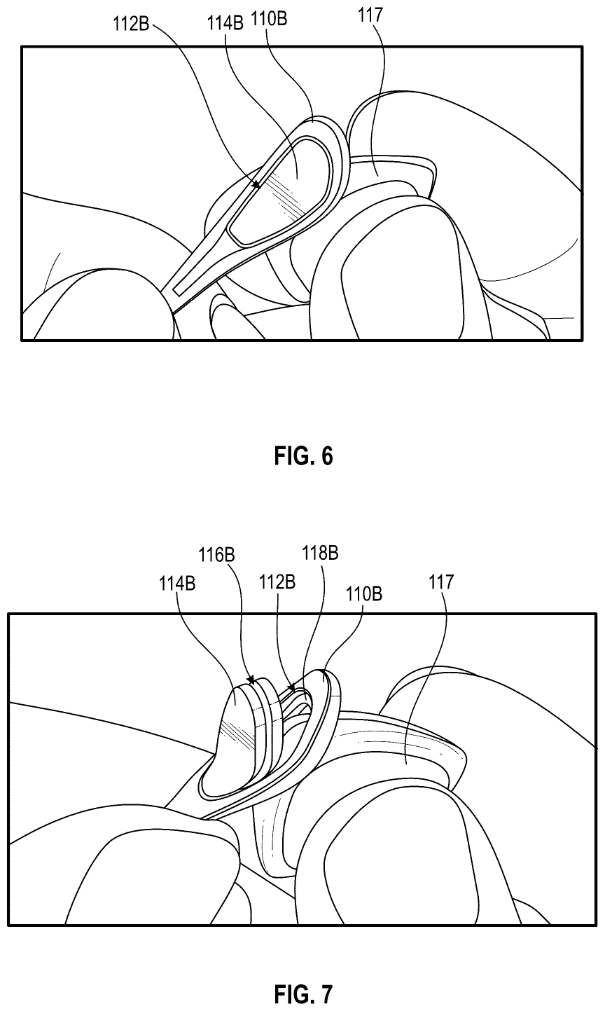

Referring to FIGS. 6-7, in some embodiments, a method of interchanging nose pads for eyewear comprises removing and interchanging the first nose pads 106A-B for the second nose pades 114A-B in the nose portion 103 and temple tip apertures 112A-B. For example, a second nose pad 114B may be removed from the temple tip aperture 112B of the temple tip 110B, such as by applying pressure (by hand or by pry tool 117) to force the second nose pad 114B from the temple tip aperture 112B (and, if equipped, releasing the tongue 118B from the groove 116B), freeing the tongue 118B from the groove 116B. The same steps may be repeated for the second nose pad 114A. It will be appreciated that the nose pads 106A-B, 114A-B are each a mirror image of one another, so that the nose pads 106A-B, 114A-B may be inserted into any available temple tip aperture 112A-B, or, as shown next, with the nose portion 103.

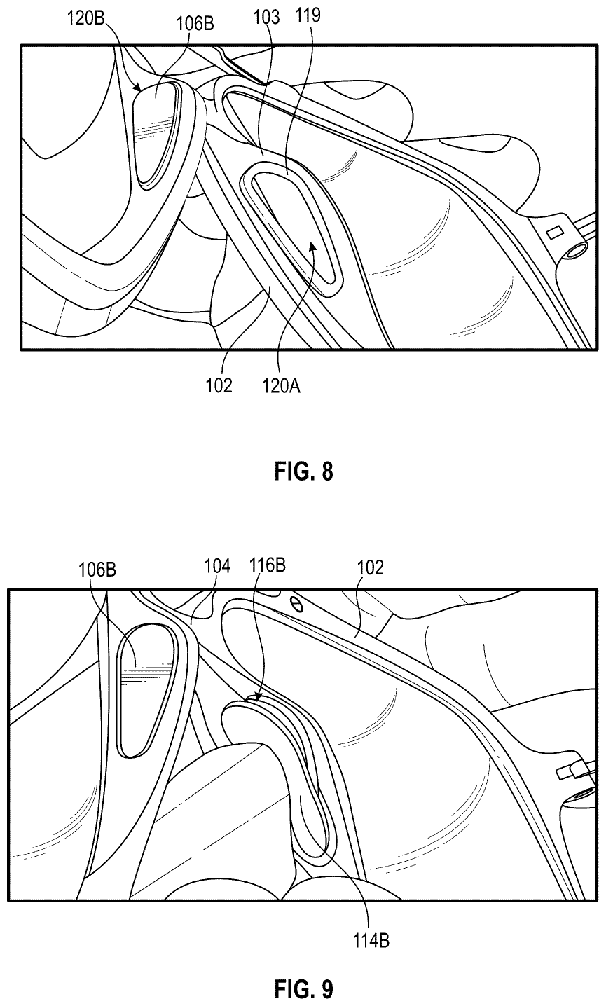

For example, referring to FIGS. 8-9, a first nose pad 106A is shown removed from the nose portion 103 in first nose aperture 120A (the removal of the nose pad 106A is the same as the steps outlined above for removal from the temple tip aperture-applying pressure to force the first nose pad 106A free). As appreciated, each nose aperture 120A-B is the same in configuration to the temple tip aperture 112A-B, with each comprising a respective tongue 119 on an inner perimeter for mating with a respective groove 116A-B of a nose pad 106A-B, 114A-B. A second nose aperture 120B may receive the first nose pad 106B or the second nose pad 114B.

As shown in FIG. 9, a second nose pad 114B may be coupled to the nose portion 103 of a frame 102 or bridge 104 via a corresponding nose aperture 120A-B, the nose aperture 120A-B being equivalent in configuration to the temple tip apertures 112A-B. In other words, a user may apply force to the nose pad 114B until the tongue 119 is mated with the groove 116B of the nose pad 114B. As a result, a user may quickly and easily change nose pads on their eyewear without having to worry about carrying a separate case and without worry of losing the second pair of nose pads, while simultaneously creating a pad for the temple tips, all of which overcomes limitations in the art.

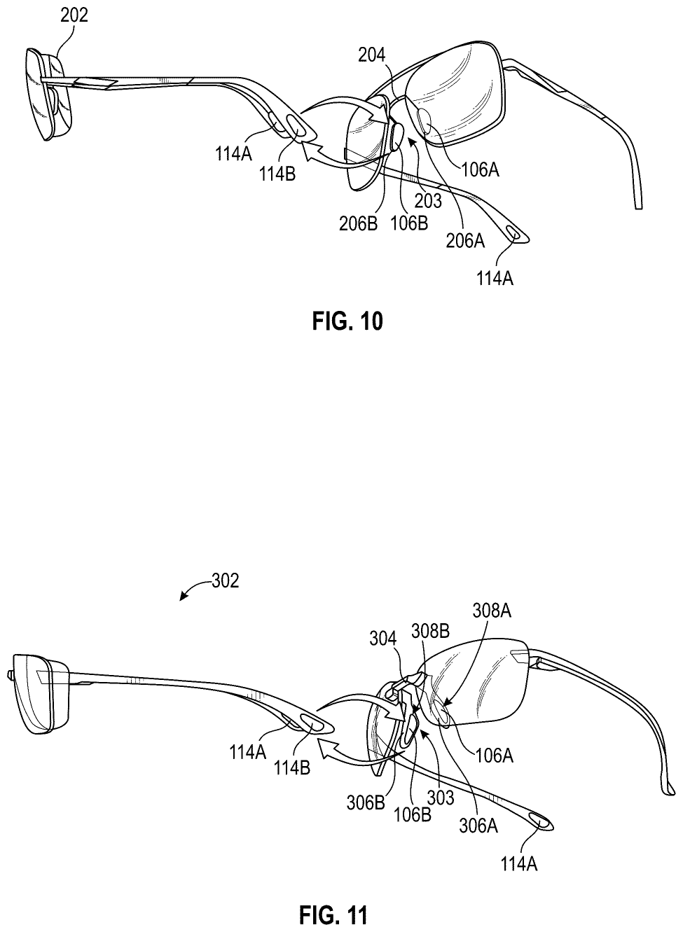

As appreciated from FIGS. 10-11, the eyewear system 100 disclosed herein may be used with a variety of eyeglasses or sunglasses, regardless of frame style, allowing a user to interchange nose pads with a second set of nose pads stored in the temple tips. For example, FIG. 10 illustrates a metal frame 202 with a nose bridge 204 extending therefrom, with the first nose pads 106A-B coupled thereto. In this example, the nose portion 203 of the bridge 204 comprises rings 206A-B sized so as to mate with the grooves 116A-B of the nose pads 106A-B, 114A-B in the same manner as the tongue previously described.

FIG. 11 illustrates rimless eyewear 302 comprising the eyewear system 100 disclosed herein. As shown, the rimless eyewear 302 comprises a bridge 304 with a nose portion 303 comprising a first nose arm 306A and a second nose arm 306B, each nose arm 306A-B comprising a nose aperture 308A-B, respectively, for receiving a nose pad 106A-B, 114A-B therein in the same manner previously described herein (e.g., tongue and groove). Accordingly, it will be appreciated that the eyewear system 100 disclosed herein may be used with a variety of styles of eyeglass and sunglasses.

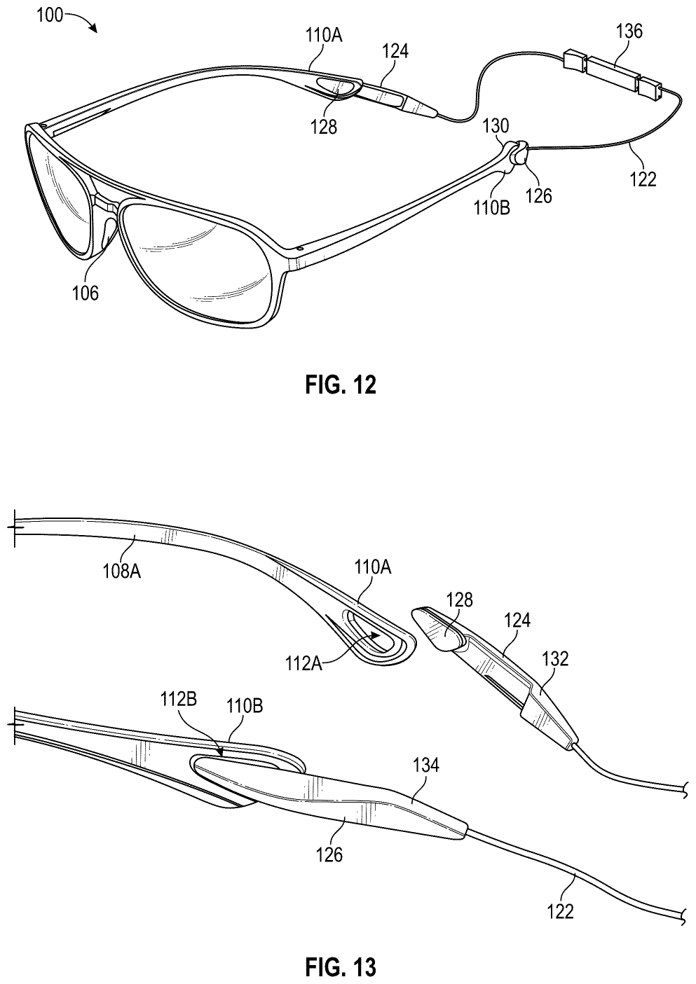

Referring now to FIGS. 12-13, the eyewear system 100 may further comprise, in some embodiments, a tether 122 comprising a first end 124 and a second end 126, wherein each end 124, 126 comprises a respective protrusion 128, 130 in the shape and configuration of the nose pads 106A-B, 114A-B as previously disclosed herein and configured to be removably securable within the respective temple tip apertures 112A-B in the same manner as the first and second nose pads 106A-B, 114A-B described earlier herein (e.g., tongue and groove). Accordingly, it will be appreciated that a user may either store a second pair of nose pads 114A-B in the temple tip apertures 112A-B, or may secure the tether 122 by securing the first and second ends 124, 126 to the temple tip apertures 112A-B via the protrusions 128, 130, respectively. It will be appreciated that a user may also selectively change between extra nose pads 114A-B and the tether 122, as desired.

By utilizing protrusions 128, 130, a user is able to utilize the tether 122 without adding excessive additional bulk to the temples or temple tips 110A-B on the inside portion, abutting a user's head, overcoming limitations in the art. Further, the protrusions 128, 130 may add cushion or a non-slip surface, which may aid in keeping the eyewear fitted to a user. The first and second ends 124, 126 may each further comprise an elongated body 132, 134, respectively, that allows a user to easily grasp the elongated body 132, 134 and use it as a lever for inserting or removing the protrusions 128, 130 into the temple tip apertures 112A-B, respectively. However, the elongated body 132, 134 is not required. The ability of a user to interchange the tether 122 with a second set of nose pads 114A-B also overcomes limitations in the art. In other words, a user may have varying types of nose pads and tethers that may all be selectively coupled to the eyewear without the need to carry a separate case or risk losing the individual components.

It will further be appreciated that the shape, size, configuration, and material of the nose pads 106A-B, 114A-B may vary without departing herefrom. In some embodiments, a user may desire to have a plurality of nose pads 106A-B, 114A-B, each pair having different characteristics. For example, a user may desire a first set of nose pads 106A-B for daily wear while utilizing alternate nose pads (e.g., nose pads 114A-B) for running or playing sports, such as extra grippy, non-slip surfaces on the nose pads 114A-B. Accordingly, a user can easily swap sport-style nose pads from the temple tips with the daily use nose pads when desired, and may easily swap back when complete with the activity. Further, a user may desire to only occasionally use a second set of nose pads, so a user may easily swap out the extra pair of nose pads 114A-B in the temple tips with the tether 122 when so desired, and then may replace the tether 122 with an extra pair of nose pads 114A-B when the tether 122 is no longer desired.

Further, it will be appreciated that the tether 122 may be manufactured from various materials and may be fixed or adjustable in length. In some embodiments, the tether 122 comprises a coated steel wire to prevent wear and tear and breakage. The tether 122 may further comprise a length adjuster 136 to allow a user to customize the fit of the tether 122. As a result, a user may easily secure the tether 122 to the desired eyewear, where it will remain secured via the temple tip apertures 112A-B, while the coated steel wire prevents breakage. While coated steel wire is used as an example, it is not required, and other materials may be used.

Accordingly, the eyewear system 100 disclosed herein solves the need for a universal, interchangeable nose pad and temple tip system that provides both comfort and convenience. Existing solutions either lack interchangeability or fail to integrate nose pads and a convenient storage solution into a cohesive system. Users often struggle with the inconvenience of lost or damaged nose pads, which can significantly affect the fit and usability of their eyewear, as well as inconsistent tethers. The eyewear system disclosed herein solves those problems and others.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An eyewear system, comprising:
a nose portion comprising a first nose aperture and a second nose aperture;
a first temple arm, the first temple arm comprising a first temple tip, the first temple tip comprising a first temple tip aperture;
a second temple arm, the second temple arm comprising a second temple tip, the second temple tip comprising a second temple tip aperture; and
a first set of nose pads, each nose pad of the first set of nose pads configured to be selectively interchangeable between the first and second nose aperture and the first and second temple tip apertures, respectively.

2. The eyewear system of claim 1, further comprising a second set of nose pads, each nose pad of the second set of nose pads configured to be selectively interchangeable between the first and second nose aperture and the first and second temple tip apertures, respectively.

3. The eyewear system of claim 2, wherein each nose pad of the first set of nose pads and each nose pad of the second set of nose pads each comprises a groove around an outer perimeter, the groove dividing a first side from a second side.

4. The eyewear system of claim 3, wherein each nose aperture and each temple tip aperture comprises a respective tongue on an inner perimeter, the tongue configured to mate with the groove of a respective nose pad of the first set and second set of nose pads.

5. The eyewear system of claim 1, further comprising a tether configured to be selectively coupled to the first and second temple tip apertures.

6. The eyewear system of claim 5, wherein the tether comprises a first end comprising a first protrusion and a second end comprising a second protrusion.

7. The eyewear system of claim 6, wherein the first protrusion is configured to be selectively coupled to the first temple tip aperture and the second protrusion is configured to be selectively coupled to the second temple tip aperture.

8. The eyewear system of claim 6, wherein the first end comprises a first elongated body and the second end comprises a second elongated body.

9. An eyewear system, comprising:
a nose portion comprising a first nose aperture and a second nose aperture;
a first temple arm, the first temple arm comprising a first temple tip, the first temple tip comprising a first temple tip aperture;
a second temple arm, the second temple arm comprising a second temple tip, the second temple tip comprising a second temple tip aperture;
a first set of nose pads, each nose pad of the first set of nose pads configured to be selectively interchangeable between the first and second nose apertures and the first and second temple tip apertures, respectively; and
a second set of nose pads, each nose pad of the second set of nose pads configured to be selectively interchangeable between the first and second nose apertures and the first and second temple tip apertures, respectively.

10. The eyewear system of claim 9, wherein each nose pad of the first set of nose pads and each nose pad of the second set of nose pads each comprises a groove around an outer perimeter, the groove dividing a first side from a second side.

11. The eyewear system of claim 10, wherein each nose aperture and each temple tip aperture comprises a respective tongue on an inner perimeter, the tongue configured to mate with the groove of a respective nose pad of the first set and second set of nose pads.

12. The eyewear system of claim 9, further comprising a tether configured to be selectively coupled to the first and second temple tip apertures.

13. The eyewear system of claim 12, wherein the tether comprises a first end comprising a first protrusion and a second end comprising a second protrusion.

14. The eyewear system of claim 13, wherein the first protrusion is configured to be selectively coupled to the first temple tip aperture and the second protrusion is configured to be selectively coupled to the second temple tip aperture.

15. The eyewear system of claim 14, wherein the first end comprises a first elongated body and the second end comprises a second elongated body.

16. A method of using an eyewear system, the method comprising:
coupling a first set of nose pads to a nose portion of an eyewear;
coupling a second set of nose pads to a first and second temple tip, respectively; and
selectively interchanging the first set of nose pads from the nose portion with the second set of nose pads from the first and second temple tips.

17. The method of claim 16, wherein the method further comprises replacing the second set of nose pads with a tether, the tether comprising a first end and a second end, each end couplable to a respective first temple tip and a second temple tip.

18. The method of claim 16, wherein the step of coupling the first set of nose pads to the nose portion comprises forcing a groove of a first nose pad of the first set of nose pads to mate with a tongue of a first nose aperture, and forcing a groove of a second nose pad of the first set of nose pads to mate with a tongue of a second nose aperture.

19. The method of claim 16, wherein the step of coupling the second set of nose pads to the first and second temple tips comprises forcing a groove of a first nose pad of the second set of nose pads to mate with a tongue of a second temple tip aperture, and forcing a groove of a second nose pad of the second set of nose pads to mate with a tongue of a second temple tip aperture.

20. The method of claim 17, wherein the step of coupling the first end of the tether and the second end of the tether to the first and second temple tips, respectively, comprises forcing a groove of a first protrusion of the first end to mate with a tongue of a first temple tip aperture, and forcing a groove of a second protrusion of the second end to mate with a tongue of a second temple tip aperture.
